(19) United States
(12) Patent Application Publication
(10) Pub. No.: US 2021/0394862 A1
(43) Pub. Date: Dec. 23, 2021

(54) BINDING ASSEMBLY WITH ANTI-ESCAPE TENSION SETTINGS FOR CLIPLESS BICYCLE PEDAL

(71) Applicant: Yong-Fu Chen, Taichung City (TW)

(72) Inventor: Yong-Fu Chen, Taichung City (TW)

(73) Assignee: SCADA INTERNATIONAL CO., LTD., Taichung City (TW)

(21) Appl. No.: 16/908,761

(22) Filed: Jun. 23, 2020

(51) Int. Cl. B62M 3/08

(52) U.S. Cl. CPC B62M 3/086

(57) ABSTRACT

The binding assembly includes a fixed binding, an adjustable binding, two torsion springs, an adjusting nut and an adjusting bolt. The fixed binding has a bow portion, a pair of stoppers and a pair of pivoting portions. The pivoting portions are passed by a pivot. The adjustable binding has an adjusting base plate and a pair of pivoting plates. The pivoting plates are passed by the pivot. Each torsion spring has an upper end and a lower end and is put around the pivot. The lower ends are stopped by the stoppers. The adjusting nut has a threaded hole and two shoulders separately abutting against the two upper ends. The adjusting bolt has a head and a threaded rod with an enlarged end. The threaded rod passes through the adjusting base plate and screws with the threaded hole. The enlarged end projects from the threaded hole and cannot escape.

### TECHNICAL FIELD

The invention relates to clipless pedals, particularly to binding mechanisms mounted on pedal bodies for engaging with cleats.

### RELATED ART

A conventional binding assembly 60 of a clipless pedal as shown in FIG. 6 has a front binding 61, a rear binding 62, at least one torsion spring 63, a pivot 64, a tension adjustment baffle 65 and an adjusting bolt 66. The front binding 61 is provided with a bow portion 610, a front pivoting portion 611 and a stopper 612. The rear binding 62 is provided with an adjusting base portion 620 and a rear pivoting portion 621. The adjusting bolt 66 is screwed into both the adjustment baffle 65 and the adjusting base portion 620. The front pivoting portion 611 of the front binding 61 is pivotedly connected with the rear pivoting portion 621 by a pivot 64. The torsion spring 63 is put around the pivot 64. An end of the torsion spring 63 is stopped by the stopper 612 and the other end of the torsion spring 63 is stopped by the tension adjustment baffle 65. The torsion from the torsion spring 63 against the tension adjustment baffle 65 can be adjusted by rotating the adjusting bolt 66 to linearly slide the tension adjustment baffle 65.

However, because no anti-escape mechanism for the tension adjustment baffle 65 is provided, the tension adjustment baffle 65 tends to escape from the adjusting bolt 66 while adjusting. Also, such adjustment cannot be implemented with a scale. Proper adjustment is hard to be made.

### SUMMARY OF THE INVENTION

An object of the invention is to provide a binding assembly with anti-escape tension settings for a clipless bicycle pedal, which can prevent the adjusting bolt from escaping the adjusting nut.

To accomplish the above object, the binding assembly of the invention includes a fixed binding, an adjustable binding, two torsion springs, an adjusting nut and an adjusting bolt. The fixed binding has a bow portion, a pair of stoppers and a pair of pivoting portions. The pivoting portions are passed by a pivot. The adjustable binding has an adjusting base plate and a pair of pivoting plates. The pivoting plates are passed by the pivot. Each torsion spring has an upper end and a lower end and is put around the pivot. The lower ends are stopped by the stoppers. The adjusting nut has a threaded hole and two shoulders separately abutting against the two upper ends. The adjusting bolt has a head and a threaded rod with an enlarged end. The threaded rod passes through the adjusting base plate and screws with the threaded hole. The enlarged end projects from the threaded hole.

### BRIEF DESCRIPTION OF THE DRAWINGS

FIG. 1 is an assembled view of the invention;

FIG. 2 is an exploded view of the invention;

FIG. 3 is a cross-sectional view of the invention;

FIG. 4 is a partially enlarged schematic view of the axial hole of the adjusting bolt of the invention;

FIG. 5 is a schematic view of the invention, which shows how to adjust tension with the adjusting bolt; and

FIG. 6 is a schematic view of a conventional binding assembly, which shows the adjusting bolt escapes after adjusting.

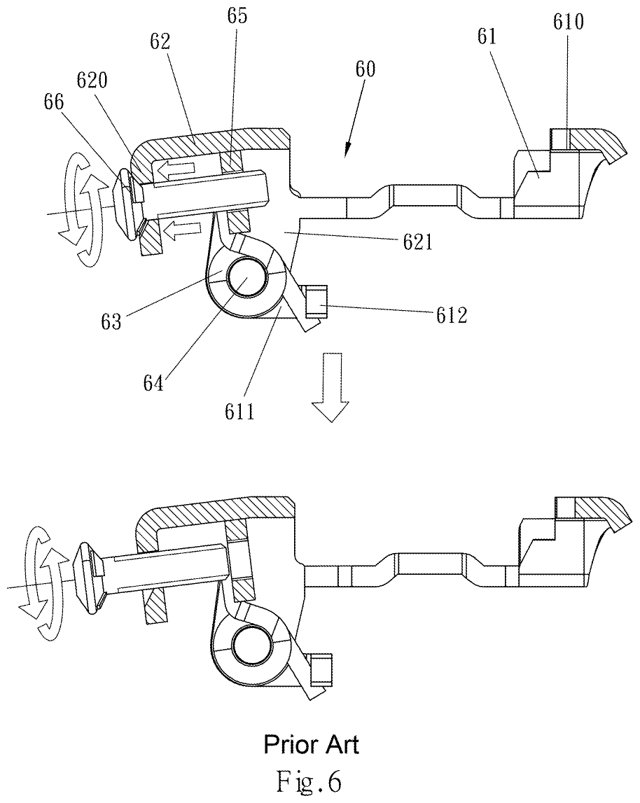

### DETAILED DESCRIPTION OF THE INVENTION

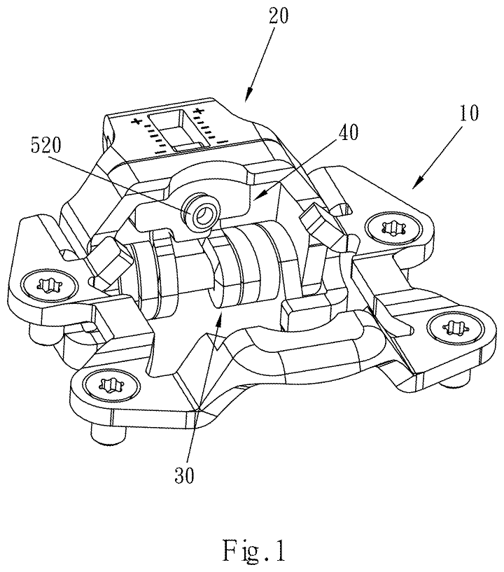

Please refer to FIGS. 1-3. The binding assembly of the invention includes a fixed binding 10, an adjustable binding 20, two torsion springs 30, an adjusting nut 40 and an adjusting bolt 50.

The fixed binding 10 has a bow portion 11, a pair of stoppers 12 and a pair of pivoting portions 13. The pivoting portions 13 are passed by a pivot 130. The adjustable binding 20 has an adjusting base plate 21 and a pair of pivoting plates 22 beside the adjusting base plate 21. The pivoting plates 22 correspond to the pivoting portions 13 and are passed by the pivot 130. Each torsion spring 30 has an upper end 31 and a lower end 32 and is put around the pivot 130. The lower ends 32 are stopped by the stoppers 12 of the fixed binding 10. The adjusting nut 40 has a threaded hole 41 at the center thereof and two shoulders 42 separately abutting against the two upper ends 31. The adjusting bolt 50 has a head 51 and a threaded rod 52. An end of the threaded rod 52 is formed with an enlarged end 520. The threaded rod 52 passes through the adjusting base plate 21 and screws with the threaded hole 41. The enlarged end 520 projects from the threaded hole 41.

The pivoting plates 22 correspond to the pivoting portions 13 and are passed by the pivot 130. The two torsion springs 30 are put around the pivot 130. The threaded rod 52 passes through the adjusting base plate 21 and screws with the threaded hole 41. The enlarged end 520 is located outside the adjusting nut 40. The lower ends 32 of the torsion springs 30 are stopped by the stoppers 12 of the fixed binding 10. The upper ends 31 are stopped by the two shoulders 42 of the adjusting nut 40. By rotating the adjusting bolt 50 to slide the adjusting nut 40, the upper ends of the torsion springs 30 can be compressed to increase torsion or stretched to decrease torsion. Also, the enlarged end 520 of the adjusting bolt 50 prevents the adjusting bolt 50 from escaping from the adjusting nut 40. It is so convenient and stable for users.

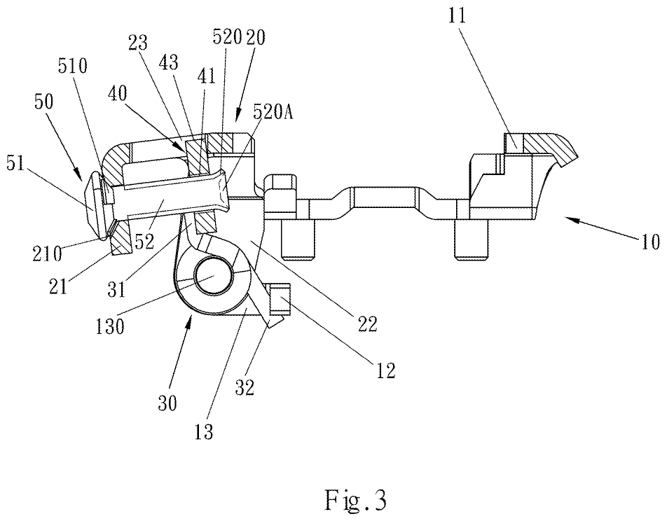

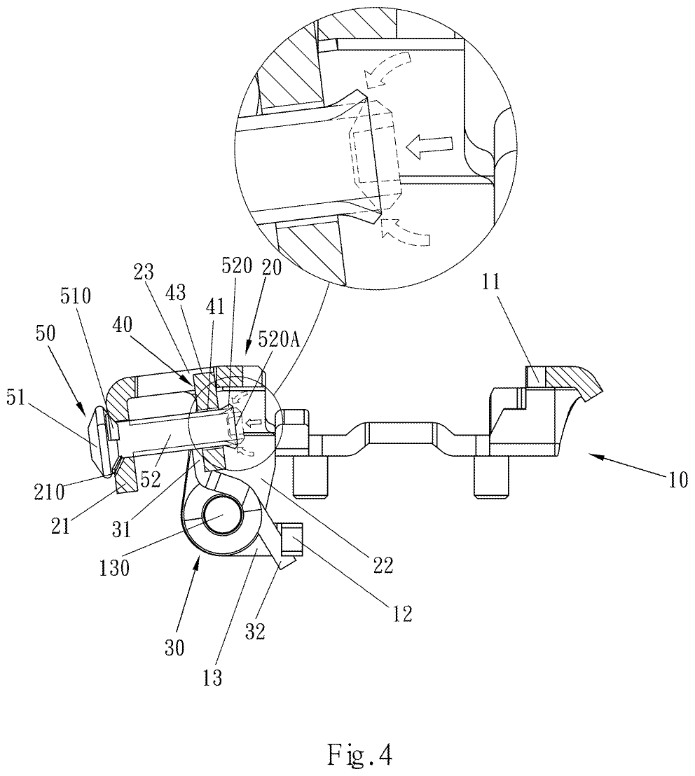

Please refer to FIGS. 3 and 4. The distal end of the threaded rod 52 is formed with an axial hole 520A. The enlarged end 520 is formed by hammering the axial hole 520A to make its periphery radially extend. The enlarged end 520 is formed after the threaded rod 52 has passed the adjustable binding 20 and screwed into the adjusting nut 40.

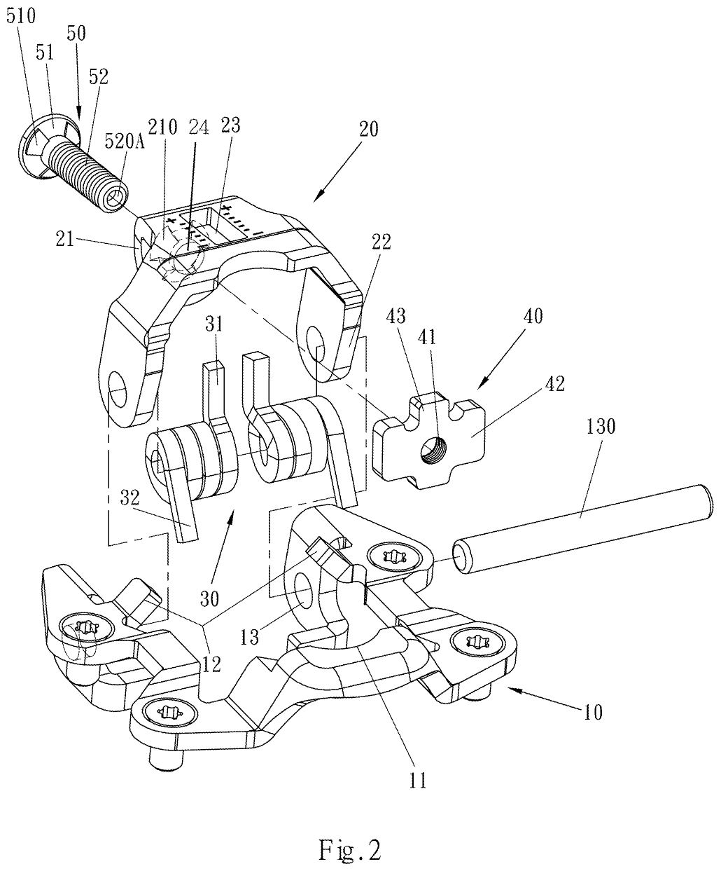

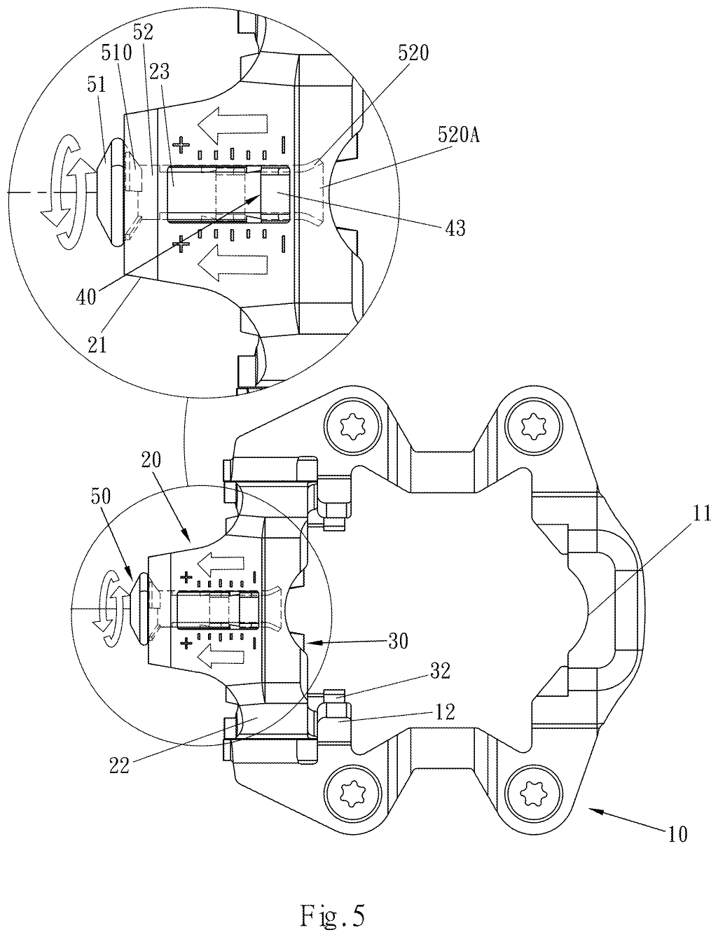

Please refer to FIGS. 2 and 5. An adjustment window 23 is formed between the adjusting base plate 21 and the pivoting plates 22 of the adjustable binding 20. The adjusting nut 40 is extended with an indicator protrusion 43. The indicator protrusion 43 is inserted into the adjustment window 23. When the indicator protrusion is moved with the adjusting nut 40, it can indicate a status of the torsion adjusted.

Please refer to FIG. 2. The through hole 24 of the adjusting base plate 21, which is passed through by the adjusting bolt 50, is provided with positioning recesses 210. An inner side of the head 51 of the adjusting bolt 50 is provided with positioning blocks 510 corresponding to the positioning recesses 210. When the adjusting bolt 50 is being rotated, the positioning blocks 510 will be separately embedded into the positioning recesses 210 to make positioning to the adjusting bolt 50.

What is claimed is:

1. A binding assembly for a clipless bicycle pedal, comprising:
a fixed binding, having a bow portion, a pair of stoppers and a pair of pivoting portions, and the pair of pivoting portions being passed by a pivot;
an adjustable binding, having an adjusting base plate and a pair of pivoting plates beside the adjusting base plate, the pair of pivoting plates corresponding to the pair of pivoting portions and being passed by the pivot;
two torsion springs, each having an upper end and a lower end, put around the pivot, and the lower ends being stopped by the stoppers;
an adjusting nut, having a threaded hole and two shoulders, the two shoulders separately abutting against the two upper ends of the torsion springs; and
an adjusting bolt, having a head and a threaded rod, a distal end of the threaded rod being formed into an enlarged end, the threaded rod passing through the adjusting base plate and screwing with the threaded hole, and the enlarged end projecting from the threaded hole.

2. The binding assembly of claim 1, wherein a distal end of the threaded rod is formed with an axial hole, and the enlarged end is formed by hammering the axial hole to make its periphery radially extend.

3. The binding assembly of claim 1, wherein an outer diameter of the enlarged end is greater than an inner diameter of the threaded hole.

4. The binding assembly of claim 1, wherein the adjusting nut has two shoulders separately abutting against the two upper ends of the torsion spring.

5. The binding assembly of claim 1, wherein the adjustable binding is provided with an adjustment window, the adjusting nut is extended with an indicator protrusion, and the indicator protrusion is inserted into the adjustment window.

6. The binding assembly of claim 1, wherein a through hole of the adjusting base plate, which is passed through by the adjusting bolt, is provided with positioning recesses, an inner side of the head of the adjusting bolt is provided with positioning blocks corresponding to the positioning recesses, and the positioning blocks are separately embedded into the positioning recesses to make positioning to the adjusting bolt.
